(19) United States
(12) Patent Application Publication
(10) Pub. No.: US 2011/0058988 A1
(43) Pub. Date: Mar. 10, 2011

(54) Reactor for the Production of Polycrystalline Silicon

(75) Inventor: Robert Stöcklinger, Feldkirchen-Westerham (DE)

(73) Assignee: G+R TECHNOLOGY GROUP AG, Regenstauf (DE)

(21) Appl. No.: 12/871,914

(22) Filed: Aug. 31, 2010

(30) Foreign Application Priority Data
Sep. 4, 2009 (DE) 102009043950.1-41

(51) Int. Cl. B01J 19/00

(52) U.S. Cl. 422/129

(57) ABSTRACT

A reactor (10) for the production of polycrystalline silicon is disclosed, comprising a reactor floor (12) exhibiting a plurality of nozzles (40), through which a gas containing silicon flows into the reactor (10). On an outer surface (33) of the reactor floor (12) a cavity (71) is circumscribed by this outer surface (33) and a wall (70), the cavity (71) providing for the distribution of the gas containing silicon to at least part of the nozzles (40).

### CROSS REFERENCE TO RELATED APPLICATIONS

This patent application claims priority of German Patent Application No. DE 10 2009 043 950.1 filed on Sep. 4, 2009 which is incorporated herein by reference.

### FIELD OF THE INVENTION

The present invention relates to a reactor for the production of polycrystalline silicon.

### BACKGROUND OF THE INVENTION

The principle processes for the production of polycrystalline silicon in a reactor according to the invention are the “Siemens Process” and the “Monosilane Process”.

In the Siemens Process Trichlorosilane (SiHCl₃) is thermally decomposed in the presence of hydrogen on heated rods of high-purity silicon at 1000-1200° C. Elemental silicon therein is growing onto the rods. The hydrogen chloride released therein is fed back into the cycle. The process is conducted at a pressure of about 6.5 bar.

In the Monosilane Process monosilane (SiH₄) is thermally decomposed in the presence of hydrogen on heated rods of high-purity silicon at 850-900° C. Elemental silicon therein is growing onto the rods. The Monosilane Process is conducted at a pressure of about 2 to 2.5 bar.

In the U.S. Pat. No. 4,179,530 a method for the accretion of pure silicon is disclosed. The reactor used therein is a container with double walls. Cooling water flows in the space between the two walls. The reactor comprises plural thin U-shaped filaments onto which the silicon is deposited. Likewise the clamps of the electrodes are cooled. The gas is supplied and withdrawn through openings in the floor of the reactor.

The German patent application DE 25 58 387 discloses a method and an apparatus for the production of polycrystalline silicon. The polycrystalline silicon is obtained by hydrogen reduction of compounds containing silicon. Through an infeed nozzle the reactants are supplied to the reaction chamber. Used reactants are withdrawn via a conduit through an outlet. Infeed and outlet are arranged opposite each other.

The German patent application DE 10 2005 042 753 A1 discloses a method for the production of granular polycrystalline silicon in a fluidised bed reactor. In the method for the production of granular polycrystalline silicon the polycrystalline silicon is deposited from a reaction gas in a fluidised bed reactor exhibiting a hot surface. This occurs at a reaction temperature of about 600 to 1100° C. The particles with deposited silicon are removed from the reactor along with reaction gas which has not reacted and with fluidising gas.

The U.S. Pat. No. RE 36,936 discloses a method for the production of high-purity polycrystalline silicon. Herein, too, the silicon is obtained by deposition from gas containing silicon. The gas circulating in the chamber precipitates on cooled surfaces provided for this purpose. The circulation of the gas can be augmented by a fan.

The unpublished German patent application DE 10 2009 003 368 A1 discloses a reactor for the production of polycrystalline silicon comprising a reactor floor exhibiting a plurality of nozzles. Through the nozzles a gas containing silicon is flowing in. Also, plural filament rods are mounted on the reactor floor. Furthermore a gas outlet for supplying used gas containing silicon to an enrichment and/or a preparation is provided. The gas outlet is located at a free end of an inner pipe, wherein the inner pipe is passed through the reactor floor.

The German patent application DE 28 54 707 A1 discloses an apparatus and a method used for the deposition of pure semiconductor material, in particular silicon, by thermal decomposition gaseous compounds of this semiconductor material. A metallic base plate has nozzles for the provision of reaction gas. Removal of the reaction gases carried out as well via base plate.

The German patent application DE 29 12 661 A1 relates to a method for the deposition of pure semiconductor material, in particular, silicon, by thermal decomposition of a compound of the semiconductor material, on the surface of a heated carrier element, which carrier element is heated by applying an electrical current thereto, so as to heat the same to the decomposition temperature of the corresponding decomposable compound in a gas-tight, closed reactor. A nozzle design is disclosed, which is used in the process for feeding the decomposable compound.

### SUMMARY OF THE INVENTION

It is an object of the invention to provide a reactor for the production of polycrystalline silicon with a reactor floor designed in such a way that the distribution of the gas containing silicon to the nozzles in the reactor floor occurs in a manner which saves space, is safe and cost-effective, and provides easy access to the further elements on the outside of the reactor floor, for example electrodes and coolant connections.

The object of the invention is achieved with a reactor for the production of polycrystalline silicon. The reactor has a reactor floor with a plurality of nozzles, wherein each nozzle has a nozzle inlet a nozzle outlet which form an infeed for a silicon containing gas to a reactor interior. At least one wall is of such a shape that it, together with an outer surface of the reactor floor, circumscribes at least one cavity, which provides for a distribution system of the silicon containing gas to at least a portion of the nozzles with which it communicates. The wall is attached to the reactor floor in a gas-tight manner in such a way that at least one surface of contact of the cavity with the outer surface of the reactor floor is restricted to a subregion of the outer surface of the reactor floor.

According to a preferred embodiment of the invention a gas supply to the reactor floor exhibits a first branch and a second branch, wherein the first branch is a gas supply to the cavity circumscribed by the wall and the outer surface of the reactor floor, and wherein the second branch is a gas supply to a central nozzle. The first and the second branch each comprise a valve, through which the flow of gas in the respective branch is controllable. It is conceivable for the other nozzles to be distributed uniformly about the central nozzle. Preferentially the invention is implemented in such a way that the cavity circumscribed by the wall and the outer surface of the reactor floor has the shape of a closed annulus. However, it is also conceivable that according to another embodiment the cavity circumscribed by the wall and the outer surface of the reactor floor has the shape of an open annulus. In an embodiment of the invention the cavity circumscribed by the wall and the outer surface of the reactor floor exhibits a cross-section which has the shape of a segment of a circle. Preferentially the wall is attached to the outer surface of the reactor floor by at least one continuous welded seam. Due to reasons of manufacture it is particularly advantageous, if the cross-section of the cavity circumscribed by the wall and the outer surface of the reactor floor is a semicircle. In this case the shape of the wall provides particularly easy access for producing the welded seam between the outer surface of the reactor floor and the wall, and also for cleaning the reactor floor.

According to a further embodiment, the reactor for the production of polycrystalline silicon has a reactor floor with a plurality of nozzles and plurality of nozzles is distributed uniformly about a central nozzle. Each nozzle has a nozzle inlet a nozzle outlet which form an infeed for a silicon containing gas to a reactor interior. At least one wall is of such a shape that it, together with an outer surface of the reactor floor, circumscribes a cavity, which provides for a distribution system of the silicon containing gas to all nozzles with which it communicates. The cavity circumscribed by the wall and the outer surface of the reactor floor has the shape of a closed annulus. The wall is attached to the reactor floor in a gas-tight manner in such a way that at least one surface of contact of the cavity with the outer surface of the reactor floor is restricted to a subregion of the outer surface of the reactor floor.

A further embodiment of the inventive reactor for the production of polycrystalline silicon shows a reactor floor with a first set of nozzles a second set of nozzles. The first set of nozzles and the second set of nozzles is distributed uniformly about a central nozzle, wherein each nozzle has a nozzle inlet a nozzle outlet which form an infeed for a silicon containing gas to a reactor interior. A wall is of such a shape that it, together with an outer surface of the reactor floor, circumscribes a cavity, wherein an individual cavity is assigned to the first set of nozzles and the second set of nozzles so that a distribution system of the silicon containing gas to the first set of nozzles and the second set of nozzles is defined. Each cavity circumscribed by the wall and the outer surface of the reactor floor has the shape of a closed annulus. The wall is attached to the reactor floor in a gas-tight manner in such a way that at least one surface of contact of the cavity with the outer surface of the reactor floor is restricted to a subregion of the outer surface of the reactor floor.

It is obvious to a person skilled in the art that further shapes and cross-sections of the cavity circumscribed by the wall and the outer surface of the reactor floor are conceivable without leaving the scope of the invention. Thus for example cross-sections in the shape of a rectangle or of a segment of an ellipse can be conceived of, the cavity could also be shaped like a U or like a meander.

The design of the gas distribution in the case of the reactor according to the invention affords the possibility to give more consideration to further requirements for the setup of the reactor, in particular the accessibility to further elements on the reactor floor, like electrical contacts or coolant connections, can be improved. Furthermore, in particular in the preferred embodiments, welded seams are reduced and connections by screws are redundant. Thereby the risk of leaks is reduced. This increases the operational safety of the reactor, as the gas containing silicon used may cause an explosion if in contact with water (for example the cooling water used in the reactor). Depending on the operational conditions, if the gas and the cooling water are in contact, also deposits may form, which reduce the reliability of the operation of the reactor. By attaching the gas distribution to the reactor floor without an intervening distance furthermore the spatial requirements of the apparatus are reduced.

### BRIEF DESCRIPTION OF THE DRAWINGS

Further features, objects and advantages of the present invention are now be explained in greater detail in the following description of a preferred embodiment of the invention, which should not be regarded as limiting the invention and which refers to the accompanying figures. Same reference numbers refer to same figures throughout the various figures and are partially not referred to repeatedly.

FIG. 1a shows a perspective section of a prior art reactor for the production of polycrystalline silicon.

FIG. 1b shows a magnified view of the principle elements of an area around a nozzle, the reactor floor and one fixture of a filament rod of the prior art reactor a shown in FIG. 1a.

FIG. 2 shows a side view of the reactor floor according to the invention with plural incoming and outgoing conduits.

FIG. 3 shows a top view of the reactor floor according to the invention from below, wherein in this cut-away view the nozzles distributed annularly are visible.

FIG. 4 shows a sectional view of the reactor floor according to the invention.

FIG. 5 shows a magnified view of a section of FIG. 4, which essentially shows a nozzle for supplying reaction gas to the interior.

FIG. 6 shows a sectional view of a further embodiment of the reactor floor according to the invention.

### DETAILED DESCRIPTION OF THE INVENTION

Identical reference numerals are used for like elements of the invention or elements of like function. Furthermore for the sake of clarity only those reference numerals are shown in the individual figures which are required for the description of the respective figure or for putting a figure into the context of other figures.

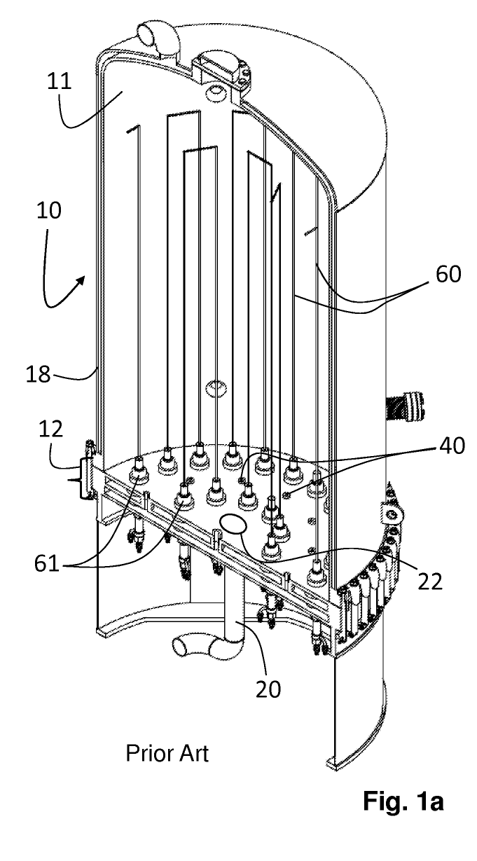

FIG. 1a shows a reactor 10 for the production of polycrystalline silicon according to prior art. The reactor floor 12 exhibits a plurality of nozzles 40, through which the gas containing silicon enters the interior 11 of the reactor 10. Also mounted on the reactor floor 12 are a plurality of filaments 60, onto which the polycrystalline silicon is deposited from the gas phase during the process. In the embodiment shown here a gas eduction 20 is furnished with a gas outlet opening 22, through which used gas is supplied to an enrichment and/or preparation. The reactor wall 18 and the inner pipe 21 are double-walled and thus can be cooled with water. The used gas is supplied to the enrichment and/or preparation via an eduction 20. Fresh silicon containing gas is supplied to the multi-layered reactor floor 12 via a supply conduit (not shown here). From there the gas is distributed within the reactor floor 12 to the individual nozzles 40 and then enters the interior 11 of the reactor 10. The nozzles 40 and the filaments 60 set into corresponding fixtures 61 are distributed uniformly about the outlet opening 22, which is formed in the reactor floor 12.

FIG. 1b essentially shows a magnified view of a section of the reactor 12 floor as shown in FIG. 1a. The reactor floor 12 is multi-layered, consisting of a first compartment 13 and a second compartment 14. The first compartment 13 is formed by a board 15 facing the interior 11 of the reactor 10 and a middle board 16. The second compartment 14 is formed by the middle board 16 and a bottom board 17. The middle board 16 exhibits openings carrying the nozzles 40 for the gas. The nozzles end in the board 15 facing the reactor interior 11 and thus furnish the outlets for the gas. Consequently the fresh gas containing silicon is supplied to the second compartment 14 and distributes in this second compartment 14, in order to enter the reactor interior 11 through the nozzles 40. In the first compartment 13 cooling water is flowing. The supply connections 62 and 63 for the filaments 60 extend below the bottom board. The supply connection 62 is for voltage supply to the filaments 60. The supply connection 62 is furnished as a high voltage electrode and supplies the filaments 60 with high voltage of about 10,000 Volts. In different embodiments the process can also be conducted with low voltage. The supply connections 63 are connections for cooling water, in order to maintain the fixtures 61 of the filaments 60 at a corresponding process temperature. The filaments 60 consist of a high-purity silicon rod with a diameter of about 8 mm.

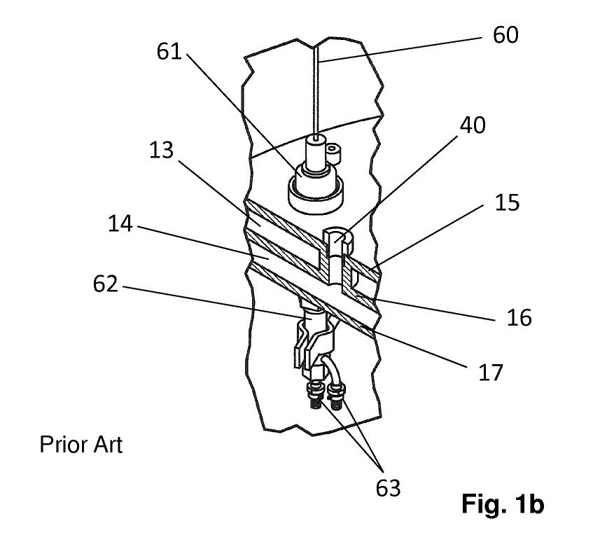

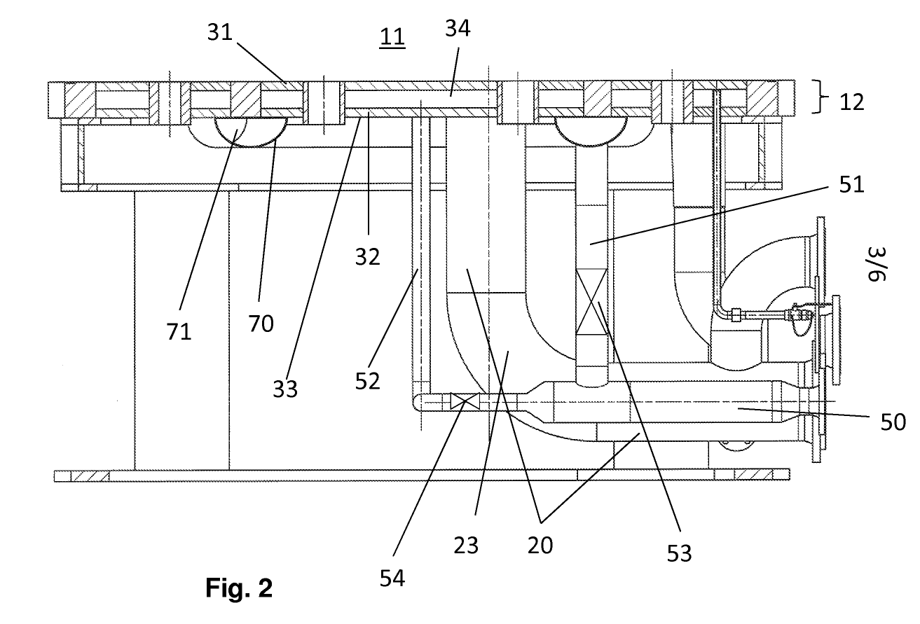

FIG. 2 shows a side view of the reactor floor 12 according to the invention. It comprises, in the embodiment shown, a first wall 31 and a second wall 32, which delimit a compartment 34. A coolant flows in the compartment 34. The first wall 31 delimits the compartment 34 against the reactor interior 11. A first outer surface 33 of the reactor floor together with a wall 70 furnishes a cavity 71, which provides for the distribution of the gas containing silicon to the nozzles 40 (see FIG. 3). In the embodiment shown a pipe 50 is a gas supply to the reactor floor; the pipe 50 branches into a first branch 51 and a second branch 52. The first branch 51 leads to the cavity 71, the second branch 52 to a central nozzle 41 (see FIG. 3), which does not communicate with the cavity 71. In the first branch there is provided a valve 53, and in the second branch a valve 54. The gas supply to the cavity 71 is controllable by the valve 53 in the first branch 51, the gas supply to the central nozzle 41 is controllable by the valve 54 in the second branch 52. In the embodiment shown the central nozzle 41 is located at the centre of the reactor floor 12. In the embodiment shown a gas eduction 20 from the reactor 10 comprises a pipe 23.

FIG. 3 is a top view of the bottom side of the reactor floor 12 according to the invention. The wall 70 is shown in a cut-away view and shows the nozzles 40 communicating with the cavity 71. As already mentioned in the context of FIG. 2, in the embodiment shown a central nozzle 41 is located at the centre of the reactor floor 12. Furthermore in this embodiment on the reactor floor 12 also the fixtures 61 of the filaments 60 are shown, which in the reactor interior 11 serve for the deposition of silicon from the gas phase during the process. In the embodiment shown the cavity 71 furnished by the wall 70 and the outer surface 33 has the shape of a closed annulus, which does not limit the scope of the invention. Further elements with reference numerals in this figure have already been described in the context of FIG. 2.

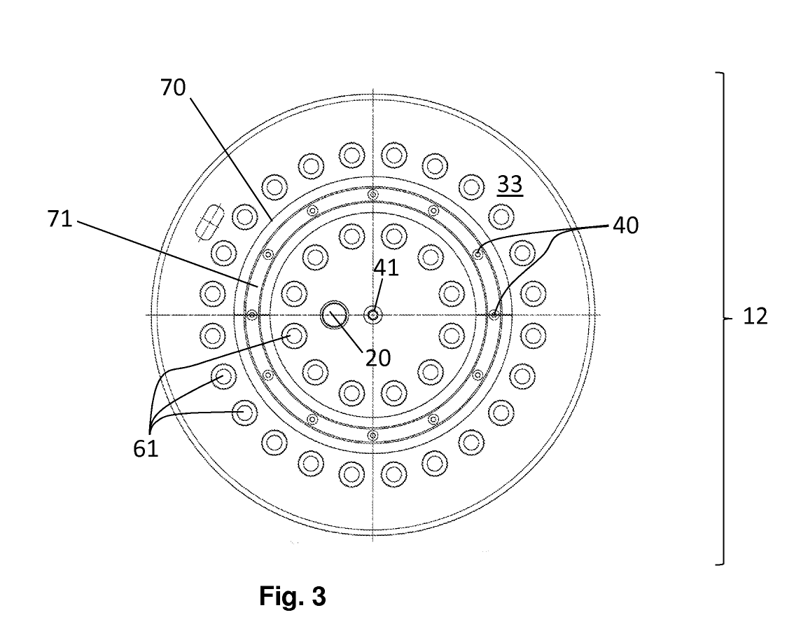

FIG. 4 is a side view of the reactor floor 12. In particular there are shown the central nozzle 41 and several of the nozzles 40 for which the distribution of the silicon containing gas is provided by the cavity 71 circumscribed by the wall 70 and the outer surface 33 of the reactor floor 12. The central nozzle 41, which in the embodiment shown is located at the centre of the reactor floor 12, is supplied with silicon containing gas via the second branch 52 (not shown here, see FIG. 2). Further elements with reference numerals in this figure have already been described in the context of FIG. 2 or 3.

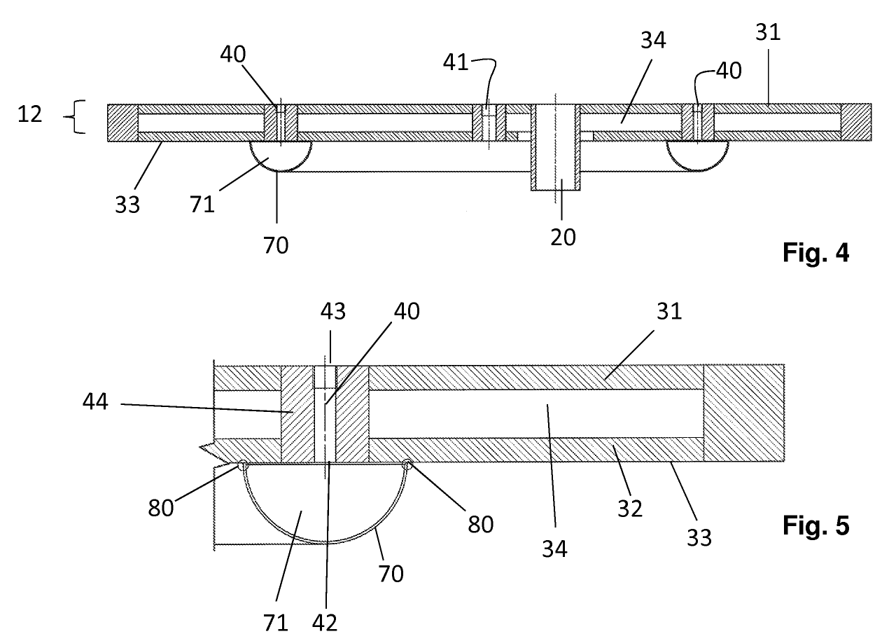

FIG. 5 shows a magnified view of a section of FIG. 4. In particular one of the nozzles 40 is shown which furnish the supply of the silicon containing gas from the cavity 71 circumscribed by the wall 70 and an outer surface 33 of the reactor floor 12 into the reactor interior 11. For the supply of gas to the reactor interior 11 the silicon containing gas enters the nozzle 40 through a nozzle inlet 42 and from there reaches the reactor interior 11 through a nozzle outlet 43. While passing the nozzle 40 the gas is separated by the nozzle wall 44 from a coolant (for example cooling water) flowing, in the embodiment shown, in the compartment 34 delimited by the first wall 31 and the second wall 32. The wall 70 is attached to the outer surface 33 of the reactor floor 12 by a welded seam 80 in a gas-tight manner.

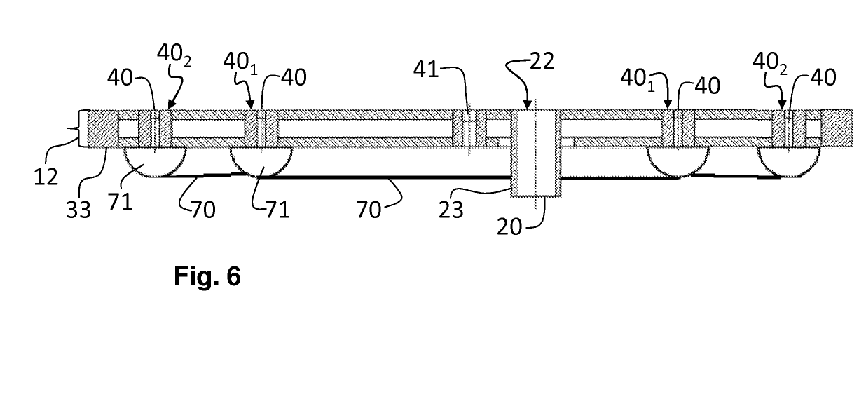

FIG. 6 is a side view of a further embodiment of the reactor floor 12. In particular there are shown the central nozzle 41 and a first set 40₁ of several of the nozzles 40 and a second set 40₂ of several of the nozzles 40, wherein a the distribution of the silicon containing gas is provided to the first set 40₁ of nozzles 40 and the second set 40₂ of nozzles 40 by an individual cavity 71 circumscribed by the wall 70 and the outer surface 33 of the reactor floor 12. The central nozzle 41, which in the embodiment shown is located at the centre of the reactor floor 12, is supplied with silicon containing gas via the second branch 52 (not shown here, see FIG. 2). The first set 40₁ of nozzles 40 and the second set 40₂ of nozzles 40 are distributed uniformly about the central nozzle 41. In the embodiment shown here, two individual cavities 71 are provided. The wall 70 is of such a shape that each cavity 70 is circumscribed by the wall and the outer surface 33 of the reactor floor 12. It is particularly advantageous if the cross-section of the cavity has the shape of a segment of a circle which is equal or less than a semicircle. This shape of the cross-section makes the welding process easier to carry out and to control.

The invention has been described with reference to preferred embodiments. It is obvious to a person skilled in the art, however, that modifications of the construction and alterations can be made without leaving the scope of the subsequent claims. In particular, in the figures the cavity 71 was shown as having the shape of an annulus and a semicircular cross-section. This in no way constitutes a limitation of the invention, other shapes and cross-sections can be conceived of, too, like for example U-shaped with rectangular cross-section.

What is claimed is:

1. Reactor for the production of polycrystalline silicon comprising: a reactor floor with a plurality of nozzles, wherein each nozzle has a nozzle inlet a nozzle outlet which form an infeed for a silicon containing gas to a reactor interior; at least one wall is of such a shape that it, together with an outer surface of the reactor floor, circumscribes at least one cavity, which provides for a distribution system of the silicon containing gas to at least a portion of the nozzles with which it communicates, and wherein the wall is attached to the reactor floor in a gas-tight manner in such a way that at least one surface of contact of the cavity with the outer surface of the reactor floor is restricted to a subregion of the outer surface of the reactor floor.

2. Reactor of claim 1, wherein the cavity circumscribed by the wall and the outer surface of the reactor floor communicates with all nozzles.

3. Reactor of claim 1, wherein a gas supply to the reactor floor exhibits a first branch and a second branch, wherein the first branch is a gas supply to the at least one cavity circumscribed by said at least one wall and the outer surface of the reactor floor, and wherein the second branch is a gas supply to a central nozzle.

4. Reactor of claim 3, wherein the plurality of nozzles is distributed uniformly about the central nozzle.

5. Reactor of claim 3, wherein at least the first branch exhibits at least one valve or at least the second branch exhibits at least one valve, through which the flow of gas in the respective branch is controllable.

6. Reactor of claim 1, wherein the cavity circumscribed by the wall and the outer surface of the reactor floor has the shape of a closed annulus.

7. Reactor of claim 1, wherein the cavity circumscribed by the wall and the outer surface of the reactor floor has the shape of an open annulus.

8. Reactor of claim 1, wherein the wall is of such a shape that the cavity circumscribed by the wall and the outer surface of the reactor floor exhibits a cross-section which has the shape of a segment of a circle.

9. Reactor of claim 8, wherein the cross-section having the shape of a segment of a circle is a semicircle.

10. Reactor of claim 1, wherein the wall is attached to the outer surface of the reactor floor by at least one continuous welded seam.

11. Reactor for the production of polycrystalline silicon comprising: a reactor floor with a plurality of nozzles and plurality of nozzles is distributed uniformly about a central nozzle, wherein each nozzle has a nozzle inlet a nozzle outlet which form an infeed for a silicon containing gas to a reactor interior; at least one wall is of such a shape that it, together with an outer surface of the reactor floor, circumscribes a cavity, which provides for a distribution system of the silicon containing gas to all nozzles with which it communicates, wherein the cavity circumscribed by the wall and the outer surface of the reactor floor has the shape of a closed annulus; and wherein the wall is attached to the reactor floor in a gas-tight manner in such a way that at least one surface of contact of the cavity with the outer surface of the reactor floor is restricted to a subregion of the outer surface of the reactor floor.

12. Reactor for the production of polycrystalline silicon comprising: a reactor floor with a first set of nozzles a second set of nozzles, wherein the first set of nozzles and the second set of nozzles is distributed uniformly about a central nozzle, wherein each nozzle has a nozzle inlet a nozzle outlet which form an infeed for a silicon containing gas to a reactor interior; a wall is of such a shape that it, together with an outer surface of the reactor floor, circumscribes a cavity, wherein an individual cavity is assigned to the first set of nozzles and the second set of nozzles so that a distribution system of the silicon containing gas to the first set of nozzles and the second set of nozzles is defined, wherein each cavity circumscribed by the wall and the outer surface of the reactor floor has the shape of a closed annulus; and wherein the wall is attached to the reactor floor in a gas-tight manner in such a way that at least one surface of contact of the cavity with the outer surface of the reactor floor is restricted to a subregion of the outer surface of the reactor floor.
